(19) United States
(12) Patent Application Publication
(10) Pub. No.: US 2025/0283803 A1
(43) Pub. Date: Sep. 11, 2025

(54) PEELING FORCE ESTIMATION METHOD, PEELING FORCE ESTIMATION PROGRAM, AND PEELING TEST APPARATUS

(71) Applicant: Kyowa Interface Science Co., Ltd., Niiza-City (JP)

(72) Inventor: Yoshinori HOSHINO, Kawagoe-shi (JP)

(21) Appl. No.: 19/045,944

(22) Filed: Feb. 5, 2025

(30) Foreign Application Priority Data
Mar. 11, 2024 (JP) 2024-036706

(51) Int. Cl. G01N 19/04

(52) U.S. Cl. CPC G01N 19/04

(57) ABSTRACT

The peeling force estimation method, for estimating peeling force in peeling a test film from an adherend surface by pulling one end of the test film that has separated from the adherend surface, where the test film is in a state of being attached to the adherend surface along a surface length direction of the adherend surface, includes: actually measuring the peeling force at a predetermined peeling angle (hereinafter, referred to as an actual measurement angle) using a peeling test apparatus to acquire an actual measured value of the peeling force, the peeling angle being defined as an angle formed between the test film and the adherend surface; and calculating the peeling force at a peeling angle other than the actual measurement angle using the actual measured value and a predetermined calculation formula representing a relationship between the peeling angle and the peeling force.

### BACKGROUND OF THE INVENTION

### Field of the Invention

The present invention relates to a peeling force estimation method and a peeling test apparatus for estimating peeling force in peeling a test film from an adherend surface.

### Description of Related Art

There is a peeling test for measuring peeling force that is the adhesive strength of adhesive tapes and adhesive sheets or the peeling adhesive strength of adhesives in general. The test method is defined in JIS Z 0237.

A test apparatus for conducting the peeling test is described in Patent Literature 1, for example. This apparatus peels a test piece from an adhesive on a base while maintaining a peeling angle of 90° by pulling up the test piece and the base via a lifting stage.

The peeling force is commonly known to vary with the peeling angle. In fact, there has thus been a demand to measure the peeling force at various peeling angles, not just the peeling angle of 90°. However, measuring the peeling force at various peeling angles solely through testing requires a significant amount of effort and can cause issues with measurement accuracy.

### BRIEF SUMMARY OF THE INVENTION

In view of this, the present invention provides a peeling force estimation method and a peeling test apparatus that can estimate the peeling force at various peeling angles using a simple technique.

A peeling force estimation method according to an aspect of the present invention is a peeling force estimation method for estimating peeling force in peeling a test film from an adherend surface by pulling one end of the test film that has separated from the adherend surface, where the test film is in a state of being attached to the adherend surface along a surface length direction of the adherend surface. The peeling force estimation method includes: actually measuring the peeling force at a predetermined peeling angle (hereinafter, referred to as an actual measurement angle) using a peeling test apparatus to acquire an actual measured value of the peeling force, the peeling angle being defined as an angle formed between the test film and the adherend surface; and calculating the peeling force at a certain peeling angle other than the actual measurement angle using the actual measured value and a predetermined calculation formula representing a relationship between the peeling angle and the peeling force.

In calculating the peeling force in the peeling force estimation method, an equation including 1/{(1−cos θ) sin θ} may be employed as the calculation formula for calculating the peeling force, where θ [°] is the peeling angle.

In calculating the peeling force in the peeling force estimation method, the following Eq. (1) for calculating a calculated value F_{c} [N] of the peeling force corresponding to the peeling angle may be employed as the calculation formula, and the calculated value F_{c} of the peeling force at the peeling angle may be calculated using the following Eq. (3) derived from the following Eq. (2) and Eq. (1):

$${F}_{c} = γ L / {\{ ( 1 - cos θ ) sin θ \}}^{n} \qquad ( 1 )$$

$${F}_{m} = γ L / {\{ ( 1 - cos {θ}_{m} ) sin {θ}_{m} \}}^{n} \qquad ( 2 )$$

$${F}_{c} = {F}_{m} \cdot {[ \{ ( 1 - cos {θ}_{m} ) sin {θ}_{m} \} / \{ ( 1 - cos θ ) sin θ \} ]}^{n} \qquad ( 3 )$$

where θ [°] is the peeling angle, L [mm] is a film width that is a dimension of the test film in a film width direction intersecting the surface length direction, γ [N/mm] is the adhesive force of the test film, n is a predetermined constant smaller than 1, θₘ [°] is the actual measurement angle, and Fₘ [N] is the actual measured value, Eq. (2) being obtained by substituting the actual measured value Fₘ into the calculated value F_{c} of the peeling force and substituting the actual measurement angle θₘ into the peeling angle θ in Eq. (1).

In the peeling force estimation method, the following Eq. (3) may be satisfied:

$${F}_{c} = {F}_{m} \cdot {[ \{ ( 1 - cos {θ}_{m} ) sin {θ}_{m} \} / \{ ( 1 - cos θ ) sin θ \} ]}^{n} \qquad ( 3 )$$

where θ [°] is the peeling angle, L [mm] is a film width that is a dimension of the test film in a film width direction interesting the surface length direction, γ [N/mm] is adhesive force of the test film, n is a predetermined constant smaller than 1, θₘ [°] is the actual measurement angle, Fₘ [N] is the actual measured value, and F_{c} is a calculated value of the peeling force.

In the peeling force estimation method, the actual measurement angle θₘ may be 90 [°].

In the peeling force estimation method, the constant n when the peeling angle θ is an angle θ2 may be set to be smaller than the constant n when the peeling angle θ is an angle θ1, the angle θ2 being greater than the angle θ1.

In the peeling force estimation method, when the peeling angle θ falls within a range of α≤0<180, the calculated value F_{c} of the peeling force at the peeling angle may be calculated using a corrected formula obtained by correcting Eq. (3), where α [°] is a predetermined threshold.

In the peeling force estimation method, the corrected formula may be the following Eq. (4):

$${F}_{c} = {F}_{m} \cdot {[ \{ ( 1 - cos {θ}_{m} ) sin {θ}_{m} \} / \{ ( 1 - cos θ ) sin θ \} ]}^{n 1} \qquad ( 4 )$$

where the constant n in Eq. (3) is replaced with a constant n1, the constant n1 being smaller than the constant n when the peeling angle θ is in a range of 0<θ<α.

In the peeling force estimation method, the threshold α may satisfy 90<α<180.

In the peeling force estimation method, the constant n may satisfy 0.4≤n≤0.7, and the constant n1 may satisfy 0.1≤n1≤0.4.

A peeling test apparatus according to an aspect of the present invention is a peeling test apparatus for peeling a test film from an adherend surface extending in a surface length direction by pulling one end of the test film that has separated from the adherend surface, where the test film is in a state of being attached to the adherend surface along the surface length direction. The peeling test apparatus includes: an adherend having the adherend surface; a base configured to support the adherend; a test film holder that is disposed on the base and is configured to support the one end of the test film; a linear moving body that is disposed on the base and is configured to linearly move the adherend with respect to the base in a longitudinal direction in which the adherend approaches and recedes from the test film holder; a rotary support that is interposed between the linear moving body and the adherend and is configured to enable rotation of the adherend with respect to the linear moving body and about a rotation center axis extending in a height direction intersecting the surface length direction and the longitudinal direction, the height direction being a film width direction of the test film attached to the adherend surface; a slide movement mechanism configured to move the adherend to slide in the surface length direction with respect to the linear moving body and the rotary support; a load measuring instrument configured to measure a load in the longitudinal direction in peeling the test film from the adherend surface; and a control apparatus configured to acquire an output signal of the load measuring instrument and to enable estimation of peeling force at each peeling angle by calculation, the peeling angle being defined as an angle formed between the test film and the adherend. The control apparatus includes: an actual measured value acquisition unit configured to acquire an actual measured value of the peeling force at a predetermined peeling angle (hereinafter, referred to as an actual measurement angle) on the basis of data actually measured by the load measuring instrument; a calculation formula storage unit configured to store a predetermined calculation formula representing a relationship between the peeling angle and the peeling force; and a peeling force calculation unit configured to calculate, using the actual measured value and the calculation formula, the peeling force at a certain peeling angle other than the actual measurement angle.

According to the foregoing peeling force estimation method and peeling test apparatus, the peeling force at various peeling angles can be estimated by a simple technique.

### BRIEF DESCRIPTION OF THE DRAWINGS

FIG. 1 is an overall top view of a peeling test apparatus used in a peeling force estimation method according to an embodiment of the present invention;

FIG. 2 is an overall top view of the peeling test apparatus, showing a state where a test film is further peeled than in the state shown in FIG. 1;

FIG. 3 is an overall top view of the peeling test apparatus, showing a state where a setting angle N is changed from in the state shown in FIG. 1;

FIG. 4 is an overall side view of the peeling test apparatus, showing a view taken in the direction of the arrow I in FIG. 1;

FIGS. 5A and 5B are schematic diagrams showing the movement of a slide movement mechanism when a peeling angle of the peeling test apparatus is changed, FIG. 5A showing a case where the setting angle N is the same as that shown in FIG. 1, FIG. 5B showing a case where the setting angle N is the same that as shown in FIG. 3;

FIG. 6 is a functional block diagram of a control apparatus of the peeling test apparatus;

FIG. 7 is a control flowchart for the control apparatus of the peeling test apparatus;

FIG. 8 is an overall top view of a peeling test apparatus according to modification 1 of the peeling test apparatus;

FIG. 9 is a schematic diagram showing a slide movement mechanism of a peeling test apparatus according to modification 2 of the peeling test apparatus;

FIG. 10 is an overall top view according to modification 3 of the peeling test apparatus;

FIGS. 11A and 11B are diagrams schematically showing a test apparatus for a distance model using a magnet sheet in experiment 1, FIG. 11A showing the apparatus with a long magnet sheet, FIG. 11B showing the apparatus with a short magnet sheet;

FIG. 12 is a diagram for describing a typical method for calculating peeling force during peeling with a constant peeling angle;

FIGS. 13A and 13B are diagrams schematically showing a test apparatus for an angle model using a magnet sheet in experiment 1, FIG. 13A showing the apparatus with a small peeling angle, FIG. 13B showing the apparatus with a large peeling angle;

FIG. 14 is a graph showing the results of experiment 1, showing a comparison between actual measured values, calculated values of peeling force on the distance model, and calculated values of peeling force on a distance-angle model;

FIGS. 15A and 15B are schematic diagrams showing the state of peeling to describe the cause of errors in the calculated values of peeling force in experiment 1, FIG. 15A showing a case where the peeling angle is small, FIG. 15B showing a case where the peeling angle is large;

FIG. 16 is a graph showing a comparison between actual measured values and calculated values of peeling force in experiment 2 at a peeling speed of 30 [mm/min];

FIG. 17 is a graph showing a comparison between actual measured values and calculated values of peeling force in experiment 2 at a peeling speed of 100 [mm/min];

FIG. 18 is a graph showing a comparison between actual measured values and calculated values of peeling force in experiment 2 at a peeling speed of 300 [mm/min];

FIG. 19 is a graph showing a comparison between actual measured values and calculated values of peeling force in experiment 2 at a peeling speed of 1,000 [mm/min];

FIG. 20 is a graph showing a comparison between actual measured values and calculated values of peeling force in experiment 2 at a peeling speed of 3,000 [mm/min];

FIG. 21 is a graph showing a comparison between actual measured values and calculated values of peeling force in experiment 3 with a substrate thickness of test film being 25 [μm];

FIG. 22 is a graph showing a comparison between actual measured values and calculated values of peeling force in experiment 3 with a substrate thickness of test film being 50 [μm];

FIG. 23 is a graph showing a comparison between actual measured values and calculated values of peeling force in experiment 3 with a substrate thickness of test film being 75 [μm];

FIG. 24 is a graph showing a comparison between actual measured values and calculated values of peeling force in experiment 3 with a substrate thickness of test film being 100 [μm]; and

FIG. 25 is a graph showing the result of a constant-speed peeling test in a simulated manner by plotting the results of constant-speed tensile tests in experiment 4.

### DETAILED DESCRIPTION OF THE INVENTION

An embodiment of the present invention will be described in detail below with reference to the drawings. While an example of a peeling test apparatus used in a peeling force estimation method according to the present embodiment will be described below, the peeling force estimation method described in detail below can use any test apparatus capable of measuring peeling force at a given peeling angle without particular limitation.

### Test Apparatus

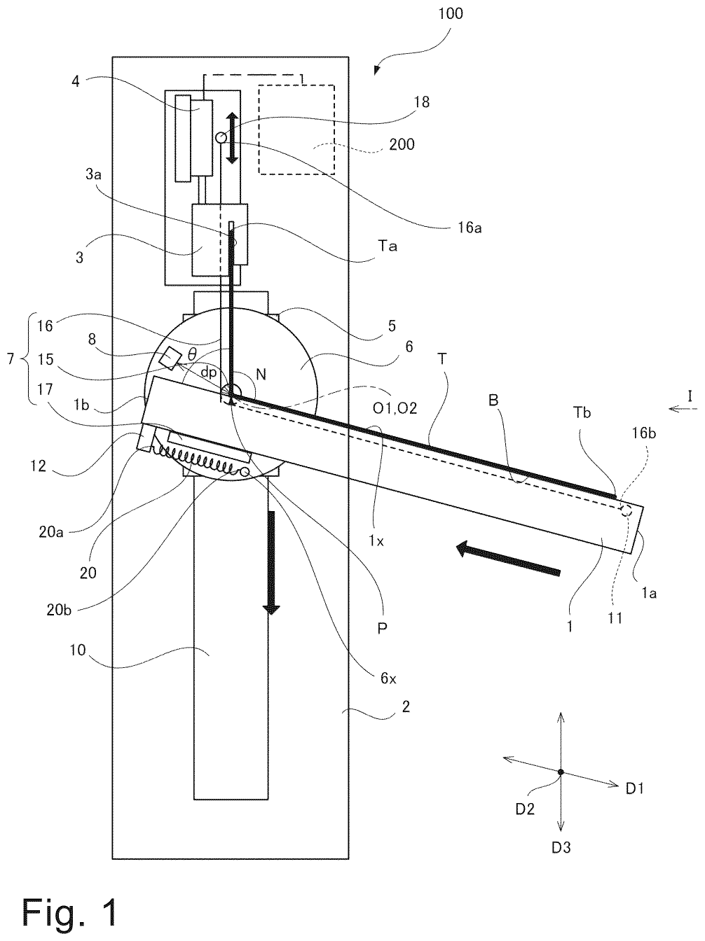

As shown in FIG. 1, a peeling test apparatus 100 is an apparatus that measures peeling force (peeling strength) in peeling a test film T from an adherend surface 1x by pulling one end Ta of the test film T that has separated from the adherend surface 1x, where the test film T is in a state of being attached to the adherend surface 1x. The peeling test apparatus 100 includes an adherend 1, a base 2, a test film holder 3, a load measuring instrument 4, a linear moving body 5, a rotary support 6, a slide movement mechanism 7, and a peeling phenomenon measurement sensor 8. The adherend 1 forms an adherend surface 1x to which the test film T is attached. The base 2 supports the adherend 1. The test film holder 3 holds the test film T on the base 2. The load measuring instrument 4 measures the load in peeling the test film T from the adherend 1. The linear moving body 5 and the rotary support 6 are interposed between the adherend 1 and the base 2. The slide movement mechanism 7 moves the adherend 1 to slide with respect to the linear moving body 5 and the rotary support 6. The peeling phenomenon measurement sensor 8 is disposed on the rotary support 6. An example of the test film T is an adhesive tape, and the surface facing one side in a thickness direction of the tape constitutes an adhesive surface B.

### Adherend

The adherend 1 has a bar-like or plate-like shape, and forms the flat adherend surface 1x extending in its longitudinal direction. The adhesive surface B of the test film T can adhere to the adherend surface 1x. The longitudinal direction of the adherend 1 will hereinafter be referred to as a surface length direction D1 of the adherend surface 1x. The test film T is attached to the adherend surface 1x along the surface length direction D1.

### Base

The base 2 is located on one side of the adherend 1 in a height direction D2 that intersects the surface length direction D1 and is along the adherend surface 1x. The base 2 movably and rotatably supports the adherend 1 via the linear moving body 5 and the rotary support 6 to be described in detail below.

In the present embodiment, the height direction D2 may be a direction along a perpendicular direction or a direction along a horizontal direction, for example. The orientation of the peeling test apparatus 100 in use is not limited in particular. In the following description, the height direction D2 is assumed to be a direction along the perpendicular direction, i.e., the base 2 is assumed to be located at the bottom of the peeling test apparatus 100.

### Test Film Holder

The test film holder 3 is located on one side in a longitudinal direction D3 that intersects the surface length direction D1 and the height direction D2, and more specifically, on the side to face the adherend surface 1x of the adherend 1 (upper side in FIG. 1). The test film holder 3 is disposed on the base 2 on the other side from the base 2 (upper side) in the height direction D2. The test film holder 3 is connected to the load measuring instrument 4 to be described in detail below. The test film holder 3 has a flat holding surface 3a facing one side in the surface length direction D1 (to the right in FIG. 1). The test film holder 3 holds the one end Ta (end not attached to the adherend 1) of the test film T by chucking the test film T with the adhesive surface B at the one end Ta of the test film T attached to the holding surface 3a.

The test film holder 3 can move back and forth in the longitudinal direction D3 with respect to the base 2 to adjust its own position on the base 2.

The configuration of the test film holder 3 is not limited in particular. The one end Ta of the test film T may be held by clamping the one end Ta of the test film T, or attaching the one end Ta without chucking or clamping.

### Load Measuring Instrument

The load measuring instrument 4 is disposed on the base 2 on one side of the test film holder 3 in the longitudinal direction D3 (upper side in FIG. 1) and is supported by the base 2. The load measuring instrument 4 measures the load acting on the test film holder 3, i.e., the load (tensile force) in the longitudinal direction D3 needed to peel the test film T from the adherend 1, i.e., the peeling force. The load measuring instrument 4 in the present embodiment includes a not-shown load cell. The load measuring instrument 4 is electrically connected to a control apparatus 200 disposed inside the base 2. An output signal from the load measuring instrument 4 is transmitted to the control apparatus 200, and the output data signal (output signal) obtained from the load measuring instrument 4 is converted into the value of the load needed for peeling (peeling force). The control apparatus 200 converts the output from the load measuring instrument 4 into the load needed to peel the test film T while taking into consideration the biasing force from a biasing member 20 to be described in detail below (force in sliding the adherend 1).

Although a detailed illustration of the hardware configuration of the control apparatus 200 is omitted, the control apparatus 200 includes a CPU and storage units such as a ROM, a RAM, and a hard disk, for example. The configuration of the load measuring instrument 4 is not limited in particular. For example, the load measuring instrument 4 may measure the load by using various methods such as strain-gauge, piezoelectric, capacitive, electromagnetic, or tuning-fork methods.

The control apparatus 200 may perform automatic position adjustment on the test film holder 3 and/or automatic position adjustment on a one-end support unit 18, to be described in detail below, that supports a transmission member 16.

### Linear Moving Body

The linear moving body 5 is located on the other side of (above) the base 2 in the height direction D2, and linearly moves the adherend 1 with respect to the base 2 in the longitudinal direction D3. More specifically, a guide member 10 extending in the longitudinal direction D3 is disposed on the base 2, and the linear moving body 5 engages with the guide member 10. This enables the linear moving body 5 to approach and recede from the test film holder 3 in the longitudinal direction D3. The linear moving body 5 is moved by a not-shown driving mechanism (such as a motor and an actuator) disposed on the base 2. The driving mechanism is controlled by the control apparatus 200, whereby the linear moving body 5 can be moved at a given speed and stopped at a given position.

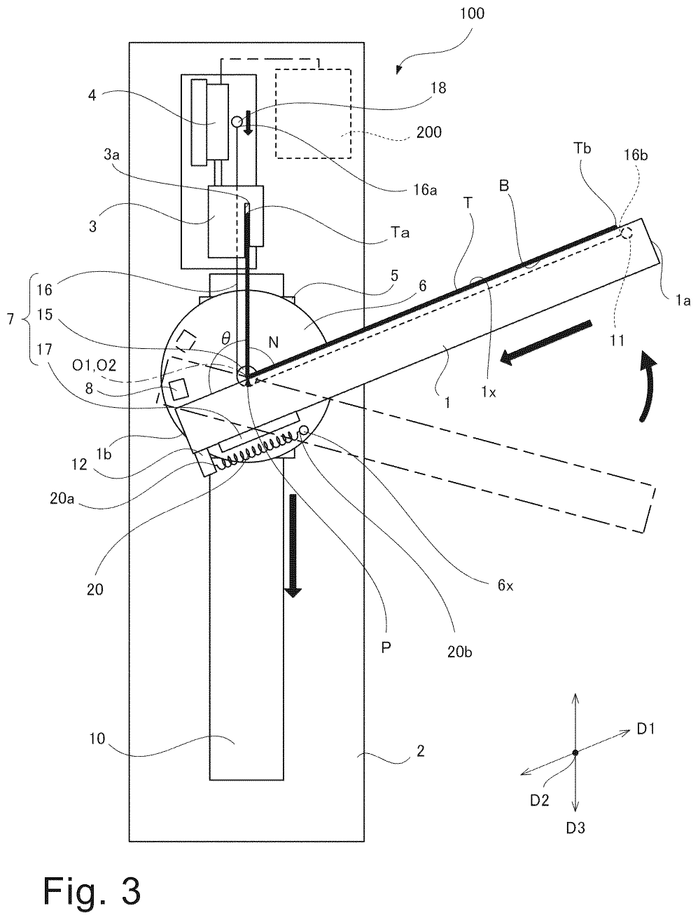

As shown in FIG. 3, the rotary support 6 is interposed between the linear moving body 5 and the adherend 1, and supports the adherend 1 so that the adherend 1 can rotate about a rotation center axis O1 extending in the height direction D2 with respect to the linear moving body 5 (and base 2). In the present embodiment, the rotation center axis O1 is located on the adherend surface 1x of the adherend 1 when seen in the height direction D2.

The rotary support 6 can be fixed at a given rotation angle by a not-shown stopper. In the present embodiment, an angle N formed between a partial area of the test film T attached to the adherend surface 1x and the remaining area of the test film T separated from the adherend surface 1x and held by the test film holder 3 can be set to a given angle within the range of 0°<N≤180° by rotating the rotary support 6. The formed angle N will hereinafter be referred to as a “setting angle N”. The setting angle N has a value obtained by subtracting the angle formed between the test film T and the adherend surface 1x, or “peeling angle θ”, from 180°.

A peeling position P on the adherend surface 1x where the test film T is peeled from the adherend surface 1x is located near the rotation center axis O1 (within 10 mm from the rotational center axis O1 in a plan view taken in the direction of the rotational center axis O1), desirably on the rotational center axis O1. The control apparatus 200 may control the operation of the rotary support 6 so that the rotary support 6 moves automatically to assume the setting angle N set (input) by the user, for example.

### Slide Movement Mechanism

The slide movement mechanism 7 moves the adherend 1 to slide with respect to the linear moving body 5 in the surface length direction D1. More specifically, the slide movement mechanism 7 includes a direction conversion member 15 that is disposed on the rotary support member 6, a transmission member 16 that is wound about the direction conversion member 15, and a slider 17 that is disposed on the rotary support 6 and holds the adherend 1 in a way that enables the slide movement.

The direction conversion member 15 in the present embodiment is a pulley (flat pulley) and located about a direction conversion axis O2 extending in the height direction D2. In the present embodiment, the direction conversion axis O2 is located coaxially with the rotation center axis O1, or equivalently, on the adherend surface 1x of the adherend 1 when seen in the height direction D2. The direction conversion member 15 is positioned in a manner where, when the direction conversion member 15 is seen in the height direction D2, the direction conversion axis O2 always falls between one end 1a and the other end 1b of the adherend 1 in the surface length direction D1. In other words, the direction conversion member 15 is provided in a position where the direction conversion axis O2 never falls outside the adherend 1 in the surface length direction D1.

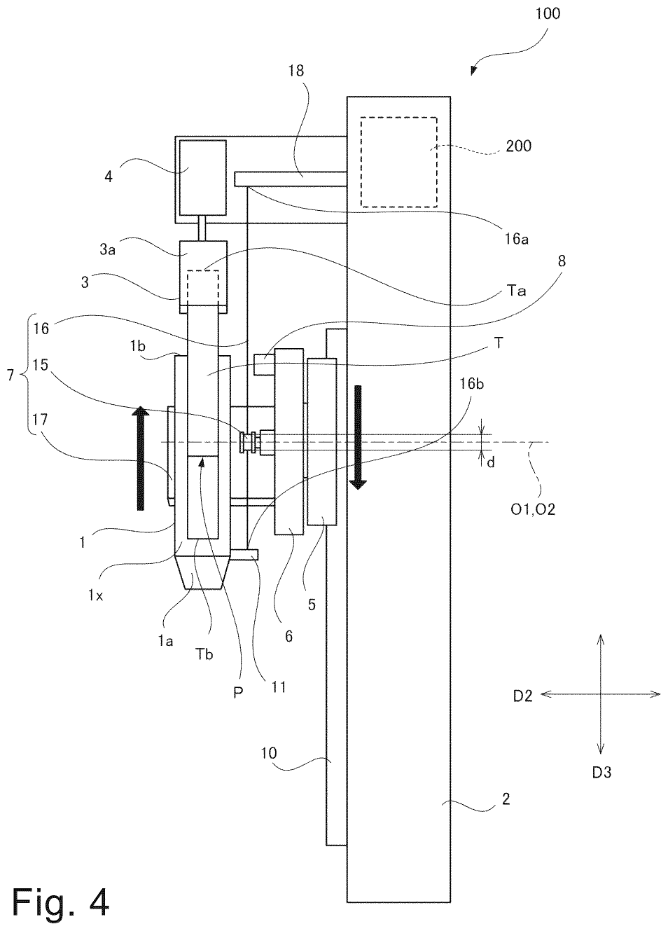

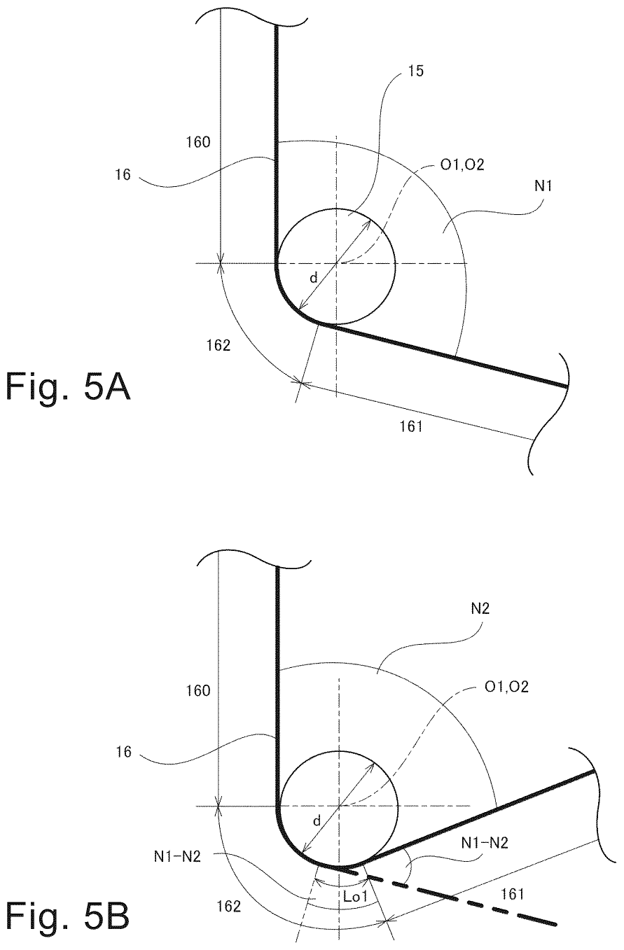

As shown in FIGS. 4, 5A, and 5B, the direction conversion member 15 may have a pulley diameter d, or nominal diameter (diameter of the surface that the transmission member 16 establishes contact with: conversion member diameter), of 30 mm or less.

The transmission member 16 is a linear member and bendable. In the present embodiment, the transmission member 16 is a metal wire. One end 16a of the transmission member 16 is supported on the base 2. More specifically, the one end 16a of the transmission member 16 is supported by a one-end side support unit 18 disposed on the base 2. The one-end side support unit 18 can move back and forth in the longitudinal direction D3 with respect to the base 2. In other words, the one end 16a of the transmission member 16 can move in the longitudinal direction D3 and can adjust the degree of tension of the transmission member 16.

The other end 16b of the transmission member 16 is supported on the adherend 1. More specifically, the other end 16b of the transmission member 16 is supported by an other-end side support unit 11 disposed on the adherend 1. The other-end side support unit 11 is located close to the one end 1a of the adherend 1 in the surface length direction D1, i.e., close to the other end Tb of the test film T attached to the adherend surface 1x.

The slider 17, although not shown in detail, includes a rail extending in the surface length direction D1, for example. The slider 17 is configured to move the adherend 1 to slide with respect to the rotary support 6 with the adherend 1 engaging with the rail.

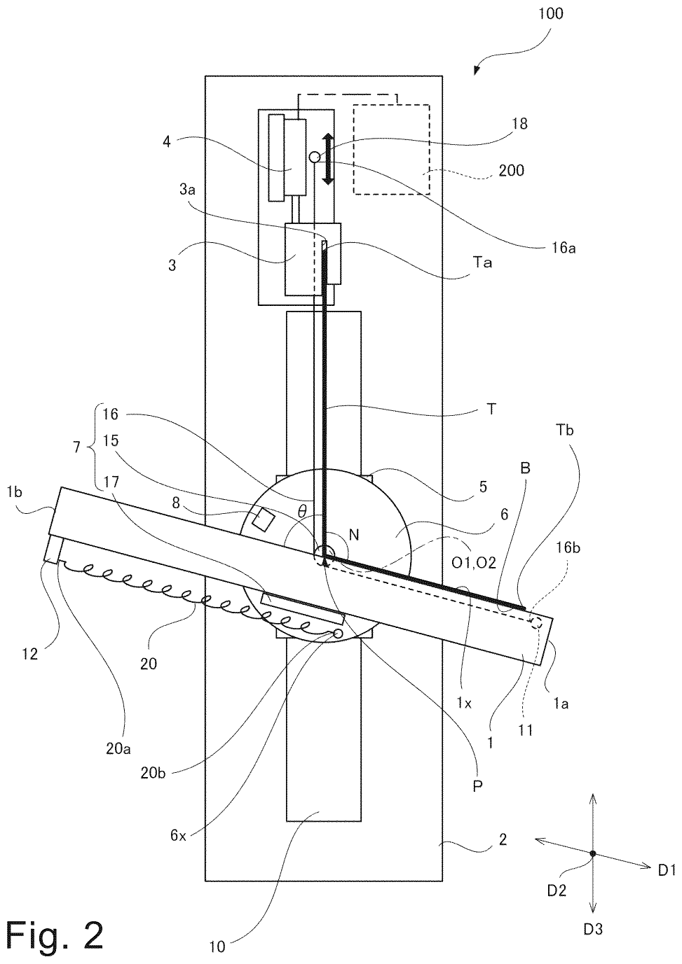

With the foregoing configuration of the slide movement mechanism 7, as the adherend 1 moves in the direction in which the linear moving body 5 recedes from the test film holder 3, the tension acting on the transmission member 16 is transmitted to the adherend 1. The adherend 1 is pulled in the surface length direction D1, and slides toward the other side in the surface length direction D1 (to the left in FIG. 1) where the test film T is peeled from the adherend surface 1x. In other words, the adherend 1 slides in a direction from the state shown in FIG. 1 into the state shown in FIG. 2.

The slide movement caused by the slide movement mechanism 7 to the side where the test film T is peeled will hereinafter be referred to as a forward slide movement.

During the slide movement, the peeling position P of the test film T does not move and remains constant in the surface length direction D1 with respect to the base 2, and moves only in the longitudinal direction D3 with respect to the base 2. During the slide movement of the adherend 1, the test film T in the region between the test film holder 3 and the direction conversion member 15 is kept in a state of being stretched in the longitudinal direction D3.

As shown in FIGS. 5A and 5B, the transmission member 16 has a holding-side region 160, a slide-side region 161, and a conversion member opposed region 162. The holding-side region 160 refers to a region between the one end 16a (see FIG. 3) and the position where the transmission member 16 comes into contact with the direction conversion member 15 on the one end 16a-side. The slide-side region 161 refers to a region between the other end 16b (see FIG. 3) and the position where the transmission member 16 comes into contact with the direction conversion member 15 on the other end 16b-side. The conversion member opposed region 162 refers to a region between the holding-side region 160 and the slide-side region 161, where the transmission member 16 is wound about the direction conversion member 15. If the rotary support 6 rotates the adherend 1 to reduce the setting angle N from N1 degrees to N2 degrees smaller than N1 degrees, the length of the direction conversion opposed region 162 increases by Lo1. The amount of change Lo1 is given by Lo1=πd×(N1−N2)/360. The one end-side support unit 18 is thus configured to allow for an adjustment of at least Lo1 to the other side in the longitudinal direction D3 (downward in FIG. 1). By contrast, if the rotary support 6 increases the setting angle N, the length of the conversion member opposed region 162 of the transmission member 16 decreases. In such a case, the position of the one end-side support unit 18 is adjusted to the one side in the longitudinal direction D3 (upward in FIG. 1).

### Biasing Member

Return to FIGS. 1 and 2. The biasing member 20 is disposed between the rotary support 6 and the adherend 1 so that the adherend 1 is biased against the slide movement (forward slide movement) of the adherend 1 to the side where the test film T is peeled. In other words, the biasing member 20 biases the adherend 1 reverse to the forward side. In the present embodiment, the biasing member 20 is a coil spring extending in the surface length direction D1, for example. One end 20a of the biasing member 20 is supported by a one-end side biasing support unit 12 that is disposed on the adherend 1 at a position close to the other end 1b. The other end 20b of the biasing member 20 is supported in the surface length direction D1 by an other-end side biasing support unit 6x that is disposed on the rotary support 6 at a position between the one end 1a and the other end 1b of the adherend 1 in the surface length direction D1.

The biasing unit 20 in the present embodiment is a “tension spring” which generates biasing force when stretched. However, this is not restrictive. For example, the biasing unit 20 may be a “compression spring” which generates biasing force when compressed. If the biasing member 20 is a compression spring, the one end 20a of the biasing member 20 is supported on the adherend 1 at a side closer to the one end 1a of the adherend 1 with respect to the other-end side biasing support unit 6x of the rotary support 6.

The biasing force of the biasing member 20 is set to be greater than the gravitational force acting on the adherend 1 in a case where the longitudinal direction D3 agrees with the vertical direction, or equivalently, in a case where the linear moving body 5 moves in the vertical direction.

### Peeling Phenomenon Measurement Sensor

The peeling phenomenon measurement sensor 8 is a sensor that measures, in a contactless manner, a physical quantity occurring at the peeling position P on the adherend surface 1x when the test film T is peeled from the adherend surface 1x. Specific examples of the peeling phenomenon measurement sensor 8 include an electrostatic sensor that measures static electricity occurring during peeling, an optical sensor (such as an image sensor) that measures light emission during peeling, and a temperature sensor that measures heat generation during peeling. The peeling phenomenon measurement sensor 8 is fixed to the rotary support 6 and opposed to the peeling position P. The distance (direct distance) dp from the peeling phenomenon measurement sensor 8 to the peeling position P is maintained constant regardless of the position of the adherend 1.

Next, a peeling force estimation method for estimating the peeling force using the foregoing peeling test apparatus 100 will be described.

The peeling force estimation method is performed by the control apparatus 200. More specifically, the control apparatus 200 has a peeling force estimation program in its memory, and performs the peeling force estimation method on the basis of the program.

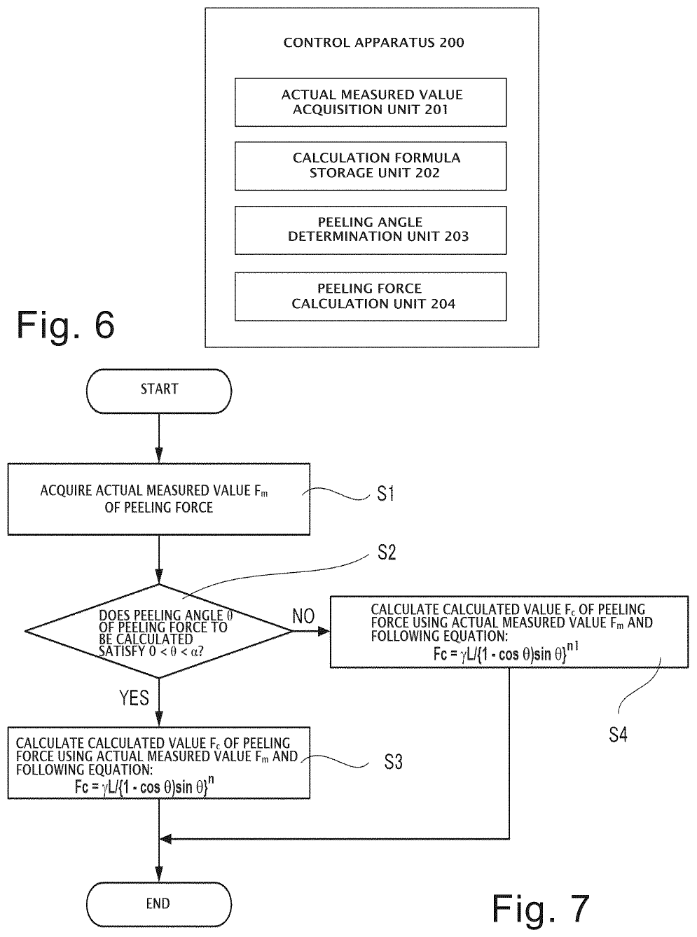

Specifically, as shown in FIG. 6, the control apparatus 200 includes an actual measured value acquisition unit 201, a calculation formula storage unit 202, a peeling angle determination unit 203, and a peeling force calculation unit 204.

The actual measured value acquisition unit 201 acquires an actual measured value Fₘ [N] of peeling force on the basis of data actually measured by the load measuring instrument 4, and records the actual measured value Fₘ.

As a predetermined calculation formula representing the relationship between the peeling angle θ and peeling force (hereinafter, referred to as a calculated value F_{c} [N]), the calculation formula storage unit 202 stores the following Eq. (1):

$${F}_{c} = γ L / {\{ ( 1 - cos θ ) ( sin θ ) \}}^{n} \qquad ( 1 )$$

In the foregoing Eq. (1), θ is the peeling angle [°] that is the angle formed between the test film T and the adherend surface, L is a film width [mm] that is the dimension of the test film T in a film width direction (the same as the height direction D2) intersecting the surface length direction D1, γ is adhesive force [N/mm] of the test film T, and n is a predetermined constant less than 1 and dependent on the material and thickness of the test film T. The constant n may be a value satisfying 0.4≤n≤0.7. In the present embodiment, n=0.58 is set, for example.

The peeling angle determination unit 203 determines which range the numerical value of the peeling angle θ, at which the peeling force is to be calculated, falls within. Specifically, with a predetermined threshold defined as α [°], the peeling angle determination unit 203 determines whether the peeling angle θ falls within the range of 0<θ<α or the range of α≤θ<180.

The peeling force calculation unit 204, as will be described in detail below, calculates the calculated value F_{c} of the peeling force at an angle other than the peeling angle (hereinafter, referred to as an actual measurement angle θₘ) at which the actual measured value Fₘ is determined, using the actual measured value Fₘ of the peeling force and the foregoing Eq. (1). As will be described in detail below, the peeling force calculation unit 204 calculates, depending on the determination result of the peeling angle determination unit 203, the calculated value F_{c} of the peeling force using an equation where the constant n in the foregoing Eq. (1) is replaced with a constant n1.

Next, a procedure for the peeling force estimation method will be described.

As shown in FIG. 7, step S1 is initially performed, where the peeling force is actually measured using the peeling test apparatus 100 to acquire the actual measured value Fₘ. In step S1, the peeling force for at least one peeling angle θ (actual measurement angle θₘ) is actually measured. The peeling angle θ for the actual measurement is not limited in particular. For example, θₘ=90 [°] can be selected.

Next, step S2 of determining whether the peeling angle θ, at which the peeling force is to be calculated, satisfies 0<θ<α is performed. The threshold α may have any value satisfying 90<α<180. In the present embodiment, α=90 [°] is set.

In step S2, if the peeling angle θ, at which the peeling force is to be calculated, falls within the range of 0<θ<α, the determination is “YES”, and the processing proceeds to step S3.

In step S3, the following Eq. (2) is obtained by substituting the actual measured value Fₘ into the calculated value F_{c} of the peeling force in the foregoing Eq. (1) and the actual measurement angle θₘ into the peeling angle θ. The calculated value F_{c} of the peeling force is then calculated using the following Eq. (3) derived from the foregoing Eq. (1) and Eq. (2),

$${F}_{m} = γ L / {\{ ( 1 - cos {θ}_{m} ) sin {θ}_{m} \}}^{n} , and \qquad ( 2 )$$

$${F}_{c} = {F}_{m} \cdot {[ \{ ( 1 - cos {θ}_{m} ) sin {θ}_{m} \} / \{ ( 1 - cos θ ) sinθ \} ]}^{n} . \qquad ( 3 )$$

On the other hand, if, in step S2, the peeling angle θ, at which the peeling force is to be calculated, falls within the range of α≤θ<180, the determination is “NO” and the processing proceeds to step S4. In step S4, the calculated value F_{c} of the peeling force is calculated using the following Eq. (4) obtained by replacing the constant n in the foregoing Eq. (1), in the case where the peeling angle θ is in the range of 0<θ<α with a constant n1 having a value smaller than that of the constant n,

$${F}_{c} = γ L / {\{ ( 1 - cos θ ) ( sin θ ) \}}^{n 1} . \qquad ( 4 )$$

The constant n1 may have any value satisfying 0.1≤n1≤0.4. In the present embodiment, n1=0.2 is set, for example.

In step S4, like step S3, the following Eq. (5) is obtained by substituting the actual measured value Fₘ into the calculated value F_{c} of the peeling force in the foregoing Eq. (4) and the actual measurement angle θₘ into the peeling angle θ. The calculated value F_{c} of the peeling force is then calculated using the following corrected formula Eq. (6) derived from the foregoing Eq. (4) and Eq. (5),

$${F}_{m} = γ L / {\{ ( 1 - cos {θ}_{m} ) sin {θ}_{m} \}}^{n 1} , and \qquad ( 5 )$$

$${F}_{c} = {F}_{m} \cdot {[ \{ ( 1 - cos {θ}_{m} ) sin {θ}_{m} \} / \{ ( 1 - cos θ ) sin θ \} ]}^{n 1} . \qquad ( 6 )$$

### Operation and Effects

According to the peeling force estimation method of the present embodiment described above, the calculated value F_{c} of the peeling force at a given peeling angle θ other than the actual measurement angle θₘ can be calculated using a predetermined calculation formula such as the foregoing Eq. (1), if an actual measured value Fₘ for at least one point is measured. The peeling force at various peeling angles can thus be estimated by a simple technique.

By using the foregoing Eq. (1) as a calculation formula for calculating the peeling force, the calculated value F_{c} approximating the actual measured value Fₘ can be calculated.

With the actual measurement angle θₘ, at which the actual measured value Fₘ of the peeling force is measured, being 90 [°], the foregoing Eq. (2) obtained by substituting the actual measured value Fₘ and the actual measurement angle θₘ into the foregoing Eq. (1) yields Fₘ=γL regardless of the value of the constant n. Consequently, the foregoing Eq. (3) results in the following Eq. (7), whereby the calculation of the calculated value F_{c} of the peeling force is much simplified,

$${F}_{c} = {F}_{m} \cdot 1 / {\{ ( 1 - cos θ ) sin θ \}}^{n} . \qquad ( 7 )$$

In a peeling test where the peeling angle θ falls within the range of α≤θ<180, i.e., the peeling angle θ is large, the elongation of the test film T can affect the actual measured value. In particular, if α is greater than or equal to 90 [°], the peeling angle θ is an obtuse angle and the foregoing effect becomes more pronounced. If the foregoing Eq. (1) is unconditionally applied to calculate the peeling force at all peeling angles θ, the calculated value F_{c} can deviate from the actual measured value Fₘ of the actual test results. By contrast, calculating the calculated value F_{c} of the peeling force using the foregoing Eq. (6) that is the corrected formula enables closer approximation of the calculated value F_{c} to the actual measured value Fₘ.

It will be understood that the present invention is not limited to the foregoing embodiment, and various changes can be made without departing from the gist of the present invention.

Eqs. (1) to (6) described above are just an example and not limited to the foregoing. For example, Eqs. (4) to (6) are not limited to the replacement of the constant n in Eqs. (1) to (3) with n1. A corrected calculated value F_{cx} can be calculated using various equations such as multiplying Eqs. (1) to (3) by correction coefficients. The process of calculating the calculated value F_{c} of the peeling force is not limited to the foregoing, either. F_{c} satisfying the foregoing Eqs. (3) and (6) may eventually be calculated through any process.

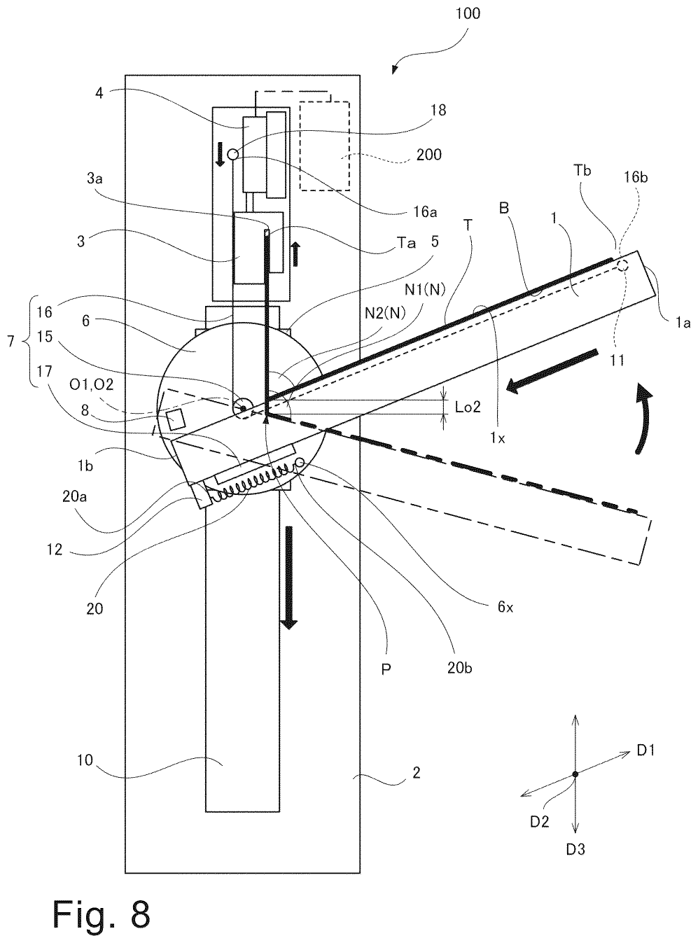

The peeling test apparatus 100 is not limited to the foregoing in particular. For example, as shown in FIG. 8, the peeling position P where the peeling film T is peeled from the adherend surface 1x may be located at a position different (away) from the rotation center axis O1. In such a case, if the setting angle N is reduced from N1 to N2, the test film T sags due to a decrease Lo2 in distance. However, the sagging of the test film T can be easily eliminated by configuring the test film holder 3 to be movable by at least Lo2 in the longitudinal direction D3. If the setting angle N is increased, the test film T becomes over-stretched. However, the position of the test film T can be similarly adjusted by moving the test film holder 3.

The rotation center axis O1 of the rotary support 6 and the direction conversion axis O2 of the direction conversion member 15 do not necessarily need to be coaxially located, but the distance between the rotation center axis O1 and the direction conversion axis O2 is desirably 5 mm or less. Such a configuration can minimize the positional deviation of the transmission member 16 (sagging or over-stretching) when the setting angle N is changed. This effect facilitates the adjustment in the position of the one-end side support unit 18 supporting the one end 16a of the transmission member 16.

Instead of or in addition to the adjustment in the position of the one-end side support unit 18 supporting the one end 16a of the transmission member 16, the position of the other-end side support member 11 supporting the other end 16b of the transmission member 16 may be made adjustable in the surface length direction D1.

For the transmission member 16, not only metal wires but linear members such as fibrous threads and plastic threads (fishing lines) may be employed. For the direction conversion member 15, not only flat pulleys but other types of pulleys such as V pulleys may be employed.

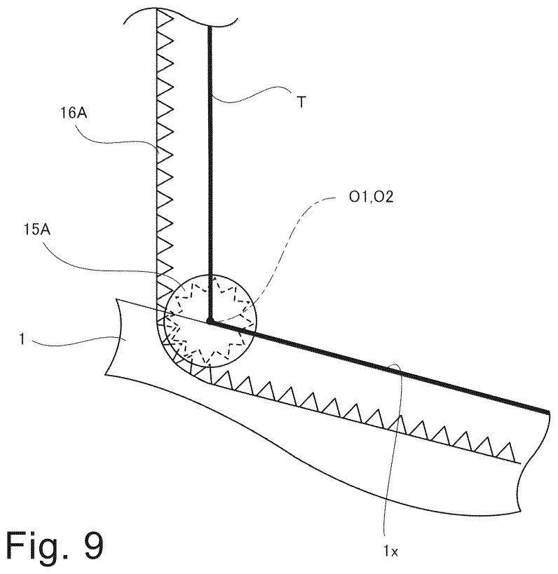

Furthermore, as shown in FIG. 9, a transmission member 16A may be a timing belt, and a direction conversion member 15A may be a timing pulley. In such a case, the position of the adherend 1 can be accurately controlled. Similarly, the transmission member 16A may be a chain, and the direction conversion member 15A may be a gear. Like the direction conversion member 15 that is a pulley, the direction conversion member 15A that is a timing pulley or a gear also desirably have a pitch circle diameter (conversion member diameter) of 30 mm or less.

The peeling phenomenon measurement sensor 8 may be disposed on the linear moving body 5. In such a case, to maintain a completely constant distance dp between the peeling phenomenon measurement sensor 8 and the peeling position P, regardless of the position of the adherend 1, the peeling position P is desirably located near the rotation center axis O1, preferably on the rotation center axis O1.

The peeling phenomenon measurement sensor 8 is also applicable to peeling test apparatuses with a slide movement mechanism having a configuration other than the foregoing. The load in peeling the test film T from the adherend surface 1x may be calculated from the physical quantity measured by the peeling phenomenon measurement sensor 8, without using the load measuring instrument 4.

In the foregoing embodiment, the constant n in the foregoing Eqs. (1) to (3) and the constant n1 in the foregoing Eqs. (4) to (6) are set in the case where the peeling angle θ is equal to the threshold α as a boundary, whereby the exponents in the equations are changed once with the threshold α as the boundary. However, for example, the constant n (exponent) may be changed a plurality of times depending on changes in the peeling angle θ. More specifically, if a given peeling angle θ1 and a given peeling angle θ2 greater than the peeling angle θ1 are selected, the constant n at the peeling angle θ2 shall be smaller than the constant n at the peeling angle θ1.

The control apparatus 200 may acquire actual measured values Fₘ of the peeling force for at least two angles including a peeling angle smaller than the threshold α and a peeling angle greater than the threshold α, for example. The foregoing constants n and n1 may then be determined by curve fitting.

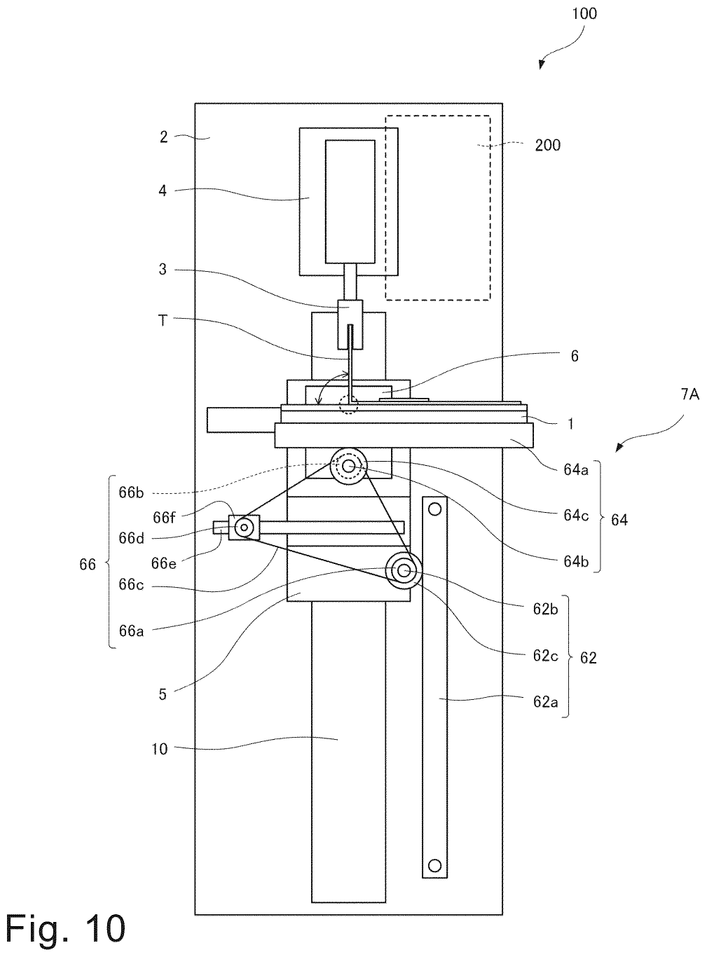

As shown in FIG. 10, a peeling test apparatus 100A may be an apparatus operating with a rack and pinion mechanism. Specifically, a slide movement mechanism 7A of the peeling test apparatus 100A includes a first conversion mechanism 62, a second conversion mechanism 64, and a transmission mechanism 66. The first conversion mechanism 62 converts the linear motion of the linear moving body 5 into rotational power and outputs the rotational power. The second conversion mechanism 64 converts the rotational power output from the first conversion mechanism 62 into linear motion of the adherend 1 with respect to the rotary support 6 and the linear moving body 5. The transmission mechanism 66 transmits the rotational power output from the first conversion mechanism 62 to the second conversion mechanism 64.

The first conversion mechanism 62 includes a first rack 62a and a first pinion 62c. The first rack 62a is a linear gear disposed on the base 2 along the moving direction of the linear moving body 5. The first pinion 62c is a gear that is rotatably disposed on the linear moving body 5 via a first rotation shaft 62b and engages with the first rack 62a.

The second conversion mechanism 64 includes a second rack 64a and a second pinion 64c. The second rack 64a is a linear gear disposed on the adherend 1 along the moving direction of the adherend 1 with respect to the rotary support 6. The second pinion 64c is a gear that is rotatably disposed on the rotary support 6 via a second rotational shaft 64b and engages with the second rack 64a.

The transmission mechanism 66 is a belt transmission mechanism, and includes a first pulley 66a, a second pulley 66b, and a toothed belt (timing belt) 66c. The first pulley 66a is connected to the first rotation shaft 62b along with the first pinion 62c. The second pulley 66b is connected to the second rotation shaft 64b along with the second pinion 64c. The toothed belt 66c is wound about the first and second pulleys 66a and 66b. The transmission mechanism 66 also includes a tension pulley 66d that is disposed in a linearly movable manner on the linear moving body 5 as a tension adjustment mechanism for the toothed belt 66c. The tension pulley 66d is disposed on the linear moving body 5 via a guide rail 66e and a slider 66f, and can change its position with respect to the first and second rotation shafts 62b and 64b on the linear moving body 5.

### Examples

A peeling simulation experiment by which the foregoing Eqs. (1) to (6) were obtained will now be described. The peeling force in peeling an adhesive tape at a constant peeling angle θ is commonly known to be proportional to 1/(1−cos θ). The inventor of the present invention has found that the peeling force is also related to a vertical component of force in the direction orthogonal to the adherend surface of the adhesive tape, and conducted the following experiment 1.

### Procedure 1: Distance Model

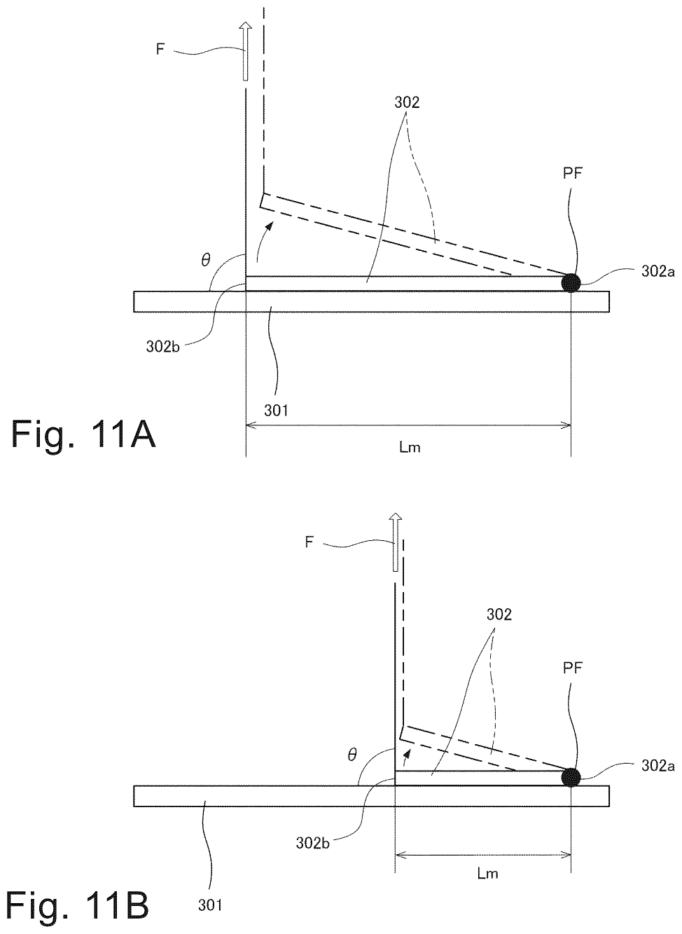

To simulate peeling, as shown in FIGS. 11A and 11B, a model (distance model) was conceived where a not-bendable magnet sheet 302 was attached to a rigid stainless base member 301. One end 302a of the magnet sheet 302 in the extending direction was pivotally fixed to a fulcrum PF on the base member 301, and the other end 302b of the magnet sheet 302 was pulled in a direction away from the base member 301 at a constant peeling angle θ(90°).

Here, the distance from the fulcrum PF to the other end 302b of the magnet sheet 302, or length Lm, was changed to change the attractive force (magnetic force) of the magnet sheet 302, and the peeling force F (peak value) in pulling the magnet sheets 302 of different lengths Lm was measured. The difference in the attractive force due to the difference in the length Lm of the magnet sheet 302 simulates the difference in the area of the region where a flexible film adheres to the base member 301 in peeling.

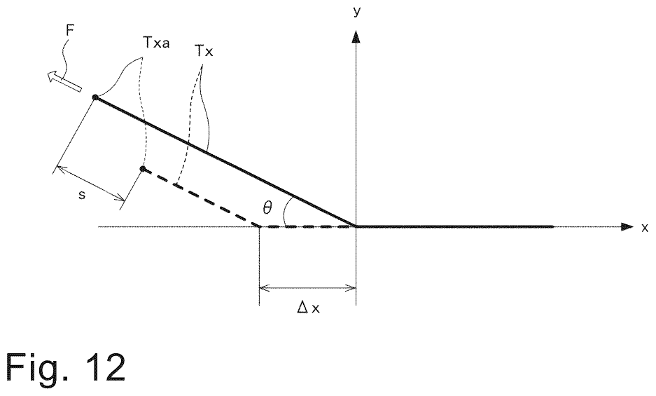

In general, as shown in FIG. 12, when a flexible film Tx is pulled off from a rigid flat surface by Δx at a peeling angle of θ, an end point Txa of the film Tx moves in the pulled direction (the direction of the arrow in FIG. 12) by a distance s. In such a case, work Fs that is the product of the film-pulling force F and the distance s is expressed by the following Eq. (8),

$$Fs = K Δ x . \qquad ( 8 )$$

K is a physical property value of the film, a constant determined by the film width and energy needed to peel a unit area of the film from the rigid flat surface.

From the geometric relationship between the distance s and Δx, the following Eq. (9) is derived,

$$s = Δ x ( 1 - cos θ ) . \qquad ( 9 )$$

The peeling force (pulling force) F is commonly known to be proportional to 1/(1−cos θ), since the following Eq. (10) is derived from the foregoing Eqs. (8) and (9),

$$F = K / ( 1 - cos θ ) . \qquad ( 10 )$$

In the present experiment 1, actual measured values Fₘ of the peeling force in peeling eleven magnet sheets 302 of respective different lengths Lm from the base member 301 were acquired. The lengths Lm of the eleven magnet sheets 302 were as follows:
Pattern 1: 61.45 [mm]
Pattern 2: 39.75 [mm]
Pattern 3: 28.00 [mm]
Pattern 4: 19.40 [mm]
Pattern 5: 14.50 [mm]
Pattern 6: 11.10 [mm]
Pattern 7: 10.00 [mm]
Pattern 8: 9.70 [mm]
Pattern 9: 8.60 [mm]
Pattern 10: 7.45 [mm]
Pattern 11: 6.45 [mm]

In the present experiment 1, the lengths Lm of the magnet sheets 302 were normalized into normalized distances with reference to the length Lm of the magnet sheet 302 of 11.10 [mm] (pattern 6). The following Table 1 shows the normalized distances of the respective patterns with the length of the magnet sheet 302 of 11.10 [mm] (pattern 6) as 1.

TABLE 1

| | | | | Actual | | |
|---|---|---|---|---|---|---|
| | Length of | | Peeling | Measured | Calcd Value Fc | Calcd Value Fc |
| | Magnetic | | Angle θ | Value Fm | (Com. Ex. 0-2) | (Example 0-1) |
| | Sheet | Normalized | (Converted | (Com. | Proportional to | Proportional to |
| | [mm] | Distance | Angle θk) | Ex. 0-1) | 1/(1 − cos θ) | 1/{(1 − cos θ)sin θ} |
| Pattern 1 | 61.45 | 5.54 | 34.97 | 1.219 | 0.676 | 1.179 |
| Pattern 2 | 39.75 | 3.58 | 43.90 | 0.582 | 0.437 | 0.630 |
| Pattern 3 | 28.00 | 2.52 | 52.90 | 0.373 | 0.307 | 0.386 |
| Pattern 4 | 19.40 | 1.75 | 64.60 | 0.211 | 0.214 | 0.271 |
| Pattern 5 | 14.50 | 1.31 | 76.40 | 0.154 | 0.159 | 0.164 |
| Pattern 6 | 11.10 | 1.00 | 90.00 | 0.122 | 0.122 | 0.122 |
| Pattern 7 | 10.00 | 0.90 | 96.50 | 0.110 | 0.110 | 0.110 |
| Pattern 8 | 9.70 | 0.87 | 98.50 | 0.107 | 0.106 | 0.107 |
| Pattern 9 | 8.60 | 0.77 | 107.50 | 0.097 | 0.094 | 0.106 |
| Pattern 10 | 7.45 | 0.67 | 119.80 | 0.088 | 0.081 | 0.094 |
| Pattern 11 | 6.45 | 0.58 | 136.00 | 0.092 | 0.071 | 0.102 |

A converted angle θₖ [°] in the case where the normalized distance of the magnet sheet 302 was 1 (pattern 6) was assumed as 90°. The converted angle θₖ refers to a peeling angle estimated from the normalized distance. Specifically, assuming that the peeling force F of the magnet sheet 302 was proportional to 1/(1−cos θ) based on the foregoing Eq. (10), the peeling angle θ in each pattern was calculated (converted) from the normalized distance=1/(1−cos θ). The foregoing Table 1 lists the calculations as converted angles θₖ.

The actual measured value Fₘ of the peeling force F at the converted angle θₖ=90° (pattern 6) will be denoted by F₉₀. From the foregoing Eq. (10), F₉₀=K. If θₖ is an angle other than 90°, i.e., in patterns 1 to 5 and 7 to 11, the calculated value F_{c} of the peeling force F is calculated by the following Eq. (11),

$${F}_{c} = {F}_{90} / ( 1 - cos θ ) . \qquad ( 11 )$$

Table 1 lists the calculated values F_{c} of the peeling force in patterns 1 to 5 and 7 to 11, calculated by the foregoing Eq. (11) as comparative example 0-2.

### Procedure 2: Angle Model

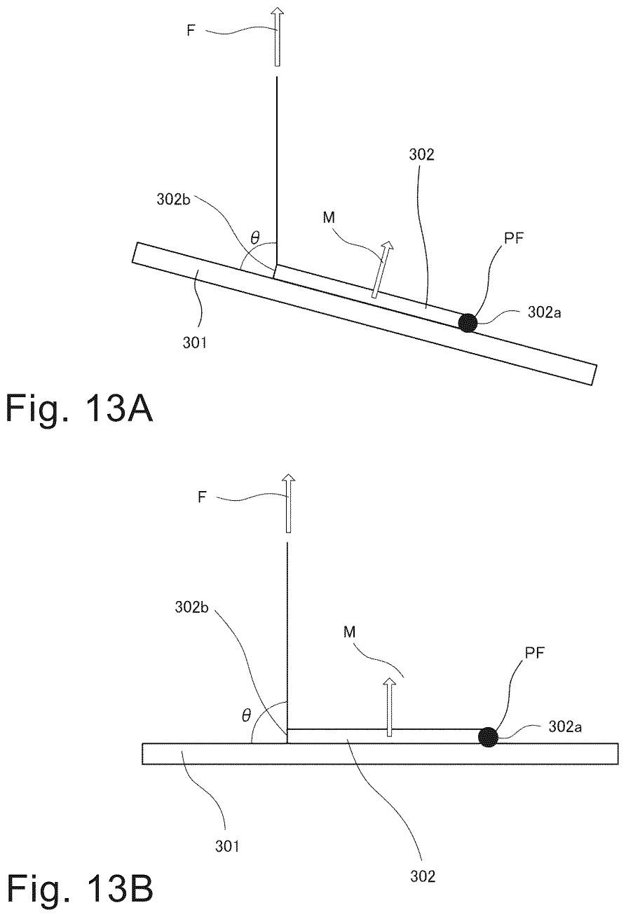

To conduct a simulation experiment using the magnet sheet 302 in a state closer to peeling, a model (angle model) shown in FIGS. 13A and 13B was also conceived. Specifically, the other end 302b of the magnet sheet 302 was pulled at various peeling angles θ with the distance from the other end 302b of the magnet sheet 302 to the fulcrum PF, i.e., the length of the magnet sheet 302 constant. This model was aimed at verifying differences in the peeling force (peak value) F due to differences in the peeling angle θ with the attractive force of the magnet sheet 302 constant. The peeling force (pulling force) F of the magnet sheet 302 can be calculated from a geometric relationship using the following Eq. (12),

$$F = M / sin θ . \qquad ( 12 )$$

In Eq. (12), M represents the attractive force [N] of the magnet sheet 302.

From the foregoing Eq. (12), the peeling force F can be confirmed to be proportional to 1/(sin θ) as well.

### Procedure 3: Distance-Angle Model

The inventor then conceived that a model (distance-angle model) combining the foregoing distance model shown in FIGS. 11A and 11B and the angle model shown in FIGS. 13A and 13B can be used to simulate the case of performing peeling while changing the peeling angle θ. The inventor conducted tests under the conditions of the length Lm of the magnet sheet 302 and the peeling angle θ (converted angle θₖ) in each of the foregoing patterns. The foregoing Table 1 lists the resulting actual measured values Fₘ of the peeling force F as comparative example 0-1.

Using the distance-angle model combining the distance model and the angle model, the calculated value F_{c} of the peeling force F was calculated by the following Eq. (13), assuming the peeling force F to be proportional to 1/(1−cos θ) and 1/(sin θ) on the basis of the foregoing Eqs. (11) and (12),

$${F}_{c} = K / \{ ( 1 - cos θ ) sin θ \} . \qquad ( 13 )$$

As described above, K is the physical property value of the film, a constant determined by the film width and the energy needed to peel a unit area of the film from the rigid flat surface.

As described above, the actual measured value Fₘ of the peeling force F at a peeling angle θ (converted angle θₖ)=90° (pattern 6) is referred to as F₉₀. From the foregoing Eq. (13), F₉₀=K. If θ is an angle other than 90°, i.e., in patterns 1 to 5 and 7 to 11, the calculated value F_{c} of the peeling force F is thus calculated by the following Eq. (14),

$${F}_{c} = {F}_{90} / \{ 1 - cos θ ) sin θ \} . \qquad ( 14 )$$

The foregoing Table 1 lists the calculated values F_{c} of the peeling force in patterns 1 to 5 and 7 to 11, calculated by the foregoing Eq. (14) as example 0-1.

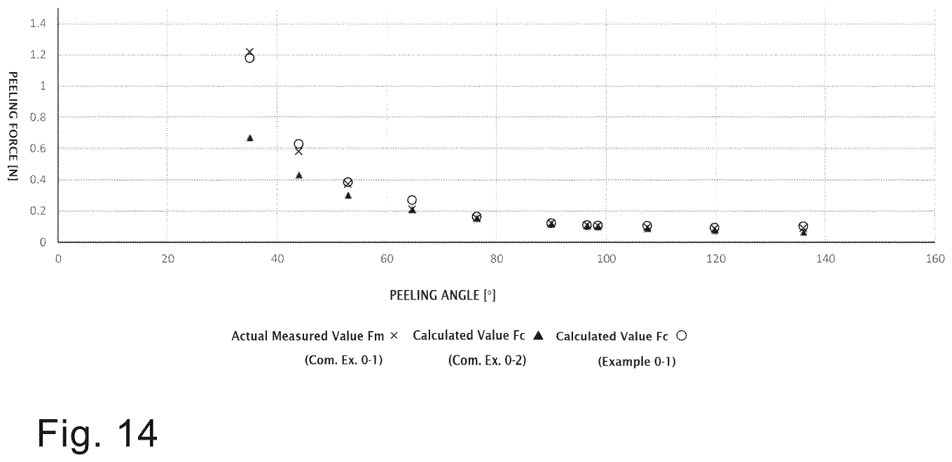

The actual measured values Fₘ (comparative example 0-1), the calculated values F_{c} (comparative example 0-2), and the calculated values F_{c} (example 0-1) were then compared. As shown in FIG. 14 that is a graphical representation of the foregoing Table 1, it was confirmed that the calculated values F_{c} of example 0-1 are closer to the actual measured values Fₘ than the calculated values F_{c} of comparative example 0-2. In other words, it was confirmed by experiment 1 that the peeling force is desirably calculated using Eq. (14), not the foregoing Eq. (11).

### Procedure 4: Error Correction

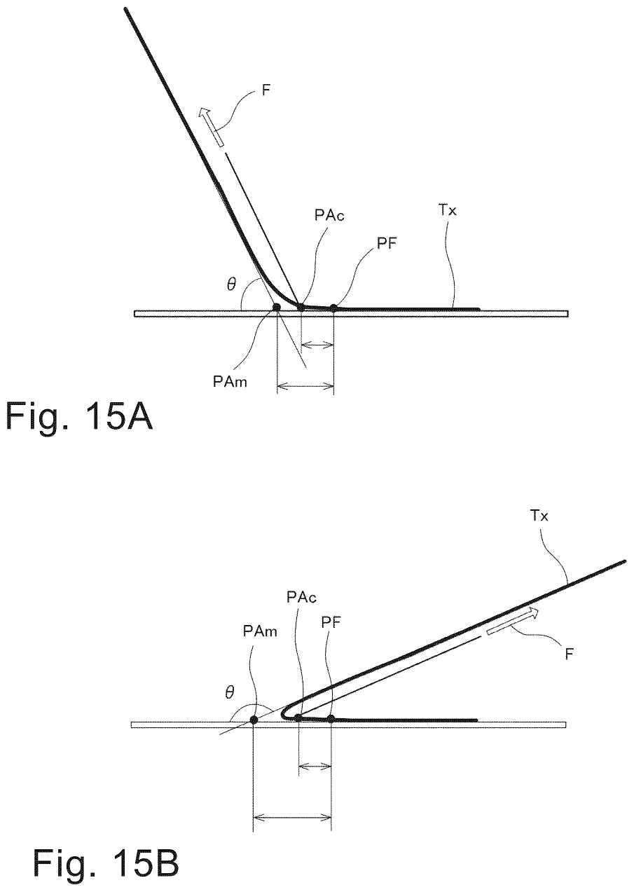

As shown in FIGS. 15A and 15B, in actual peeling, unlike the magnet sheet 302, the test film Tx deforms to curve during peeling. When the pulling force F is applied, the test film Tx thus deforms to curve from the fulcrum PF. Here, the actual point of action PAm of the pulling force F is located away from the fulcrum PF compared to the calculation point of action PAC, and the actual measured value Fₘ becomes greater than the calculated value F_{c} of the peeling force calculated using the foregoing Eq. (14). In view of this, the inventor has come up with the idea of raising {(1−cos θ) sin θ} on the right-handed side of the foregoing Eq. (14) to the power of a predetermined constant n less than 1, and conceived the foregoing Eqs. (1) to (3).

The tendency of the actual point of action PAm deviating from the calculation point of action PAc becomes more pronounced when the peeling angle θ is large (for example, 90° or more) as shown in FIG. 15B than when the peeling angle θ is small (for example, less than) 90° as shown in FIG. 15A. In view of this, the inventor has come up with the idea of raising {(1−cos θ) sin θ} on the right-handed side of the foregoing Eq. (14) to the power of a predetermined constant n1 smaller than 1 and even smaller than the constant n, and conceived the foregoing Eqs. (4) to (6).

### Experiment 2

Next, the result of experiment 2 will be described. In experiment 2, the calculated values F_{c} of the peeling force calculated using the foregoing Eqs. (1) to (3) and the calculated values F_{c} (hereinafter, referred to as corrected calculated values F_{cx}) of the peeling force calculated using the foregoing Eqs. (4) to (6) for the case where the peeling angle θ falls within the range of 90≤θ<180 were compared with the actual measured values Fₘ measured by a constant-speed peeling test using the peeling test apparatus.

### Experiment Conditions

Test films were 25-μm-thick PET resin substrates to which an adhesive was applied in a thickness of 30 [μm]. The peeling speed was set in the following five patterns (comparative examples):
Comparative example 1-1: peeling speed 30 [mm/min]
Comparative example 1-2: peeling speed 100 [mm/min]
Comparative example 1-3: peeling speed 300 [mm/min]
Comparative example 1-4: peeling speed 1,000 [mm/min]
Comparative example 1-5: peeling speed 3,000 [mm/min]
   In each of the five comparative examples, the test was conducted at peeling angles of 300, 45°, 60°, 75°, 90°, 105°, 120°, 135°, 150°, 165°, and 175°.

### Calculated Values

Examples corresponding to the foregoing respective comparative examples were as follows:
Example 1-1: peeling speed 30 [mm/min]
Example 1-2: peeling speed 100 [mm/min]
Example 1-3: peeling speed 300 [mm/min]
Example 1-4: peeling speed 1,000 [mm/min]
Example 1-5: peeling speed 3,000 [mm/min]
   In each of the examples, the calculated value F_{c} of the peeling force at each peeling angle was calculated with the constant n=0.58 in the foregoing Eq. (1). The actual measured value Fₘ substituted into the foregoing Eq. (1) was the value for a peeling angle θ of 90 [°].

### Corrected Calculated Values

In each of the following examples, the corrected calculated value F_{cx} of the peeling force at each peeling angle was calculated with the constant n1=0.2 in the foregoing Eq. (4) when the peeling angle θ was in the range of 90≤0<180:
Example 1-6: peeling speed 30 [mm/min]
Example 1-7: peeling speed 100 [mm/min]
Example 1-8: peeling speed 300 [mm/min]
Example 1-9: peeling speed 1,000 [mm/min]
Example 1-10: peeling speed 3,000 [mm/min]
   In the range where the peeling angle θ was 0<θ<90, the calculated value F_{c} of the peeling force was calculated using the foregoing Eq. (1) with the constant n=0.58. The corrected calculated values F_{cx} in this range agree with the calculated values F_{c}.

In each of the following examples, a corrected calculated value F_{cx′} of the peeling force at each peeling angle was calculated using the following Eq. (7) when the peeling angle θ was in the range of 90≤0<180:

$${F}_{cx} = γ L / {\{ ( 1 - cos θ ) ( sin θ ) \}}^{0.2} \times 0.9 \qquad ( 15 )$$

Example 1-11: peeling speed 30 [mm/min]
Example 1-12: peeling speed 100 [mm/min]
Example 1-13: peeling speed 300 [mm/min]
Example 1-14: peeling speed 1,000 [mm/min]
Example 1-15: peeling speed 3,000 [mm/min]
   Eq. (15) is obtained by setting the constant n1=0.2 in the foregoing Eq. (4), and multiplying the right-handed side of Eq. (4) by a correction factor β=0.9. In the range where the peeling angle θ was in the range of 0<θ<90, the calculated value F_{c} of the peeling force was calculated using the foregoing Eq. (1) where the constant n=0.58. The corrected calculated values F_{cx′} in this range agree with the calculated values F_{c}.

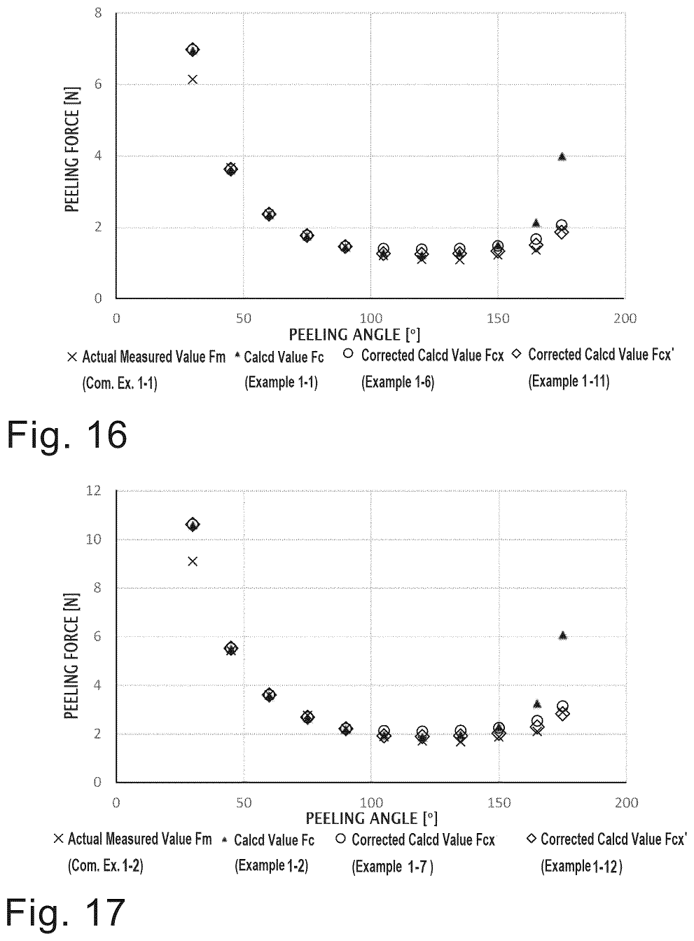

FIG. 16 shows the values of comparative example 1-1 and examples 1-1, 1-6, and 1-11 at each peeling angle, with a peeling speed of 30 [mm/min].

FIG. 17 shows the values of comparative example 1-2 and examples 1-2, 1-7, and 1-12 at each peeling angle, with a peeling speed of 100 [mm/min].

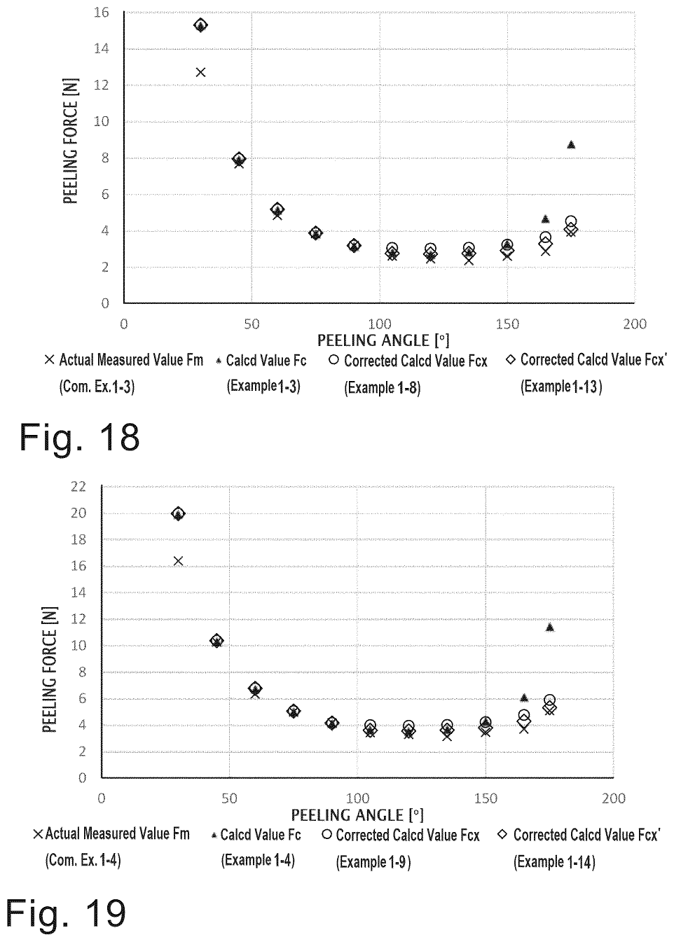

FIG. 18 shows the values of comparative example 1-3 and examples 1-3, 1-8, and 1-13 at each peeling angle, with a peeling speed of 300 [mm/min].

FIG. 19 shows the values of comparative example 1-4 and examples 1-4, 1-9, and 1-14 at each peeling angle, with a peeling speed of 1,000 [mm/min].

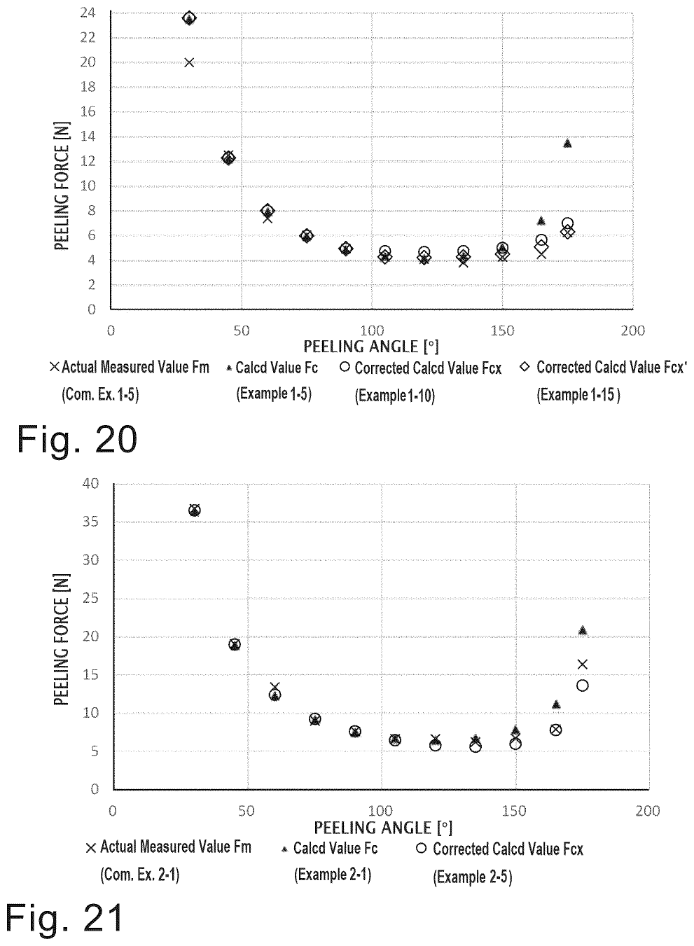

FIG. 20 shows the values of comparative example 1-5 and examples 1-5, 1-10, and 1-15 at each peeling angle, with a peeling speed of 3,000 [mm/min].

### Comparative Analysis

As shown in FIGS. 16 to 20, the calculated values F_{c} of the foregoing Eq. (1) tend to approximate the actual measured values Fₘ at any peeling speed. However, if the peeling angle θ is in the range of 90≤0<180, the corrected calculated values F_{cx} calculated using the foregoing Eq. (15) can be confirmed to more closely approximate the actual measured values Fₘ than the calculated values F_{c}. If the peeling angle θ is in the range of 90≤θ<180, the corrected calculated values F_{cx′} calculated using the foregoing Eq. (7) can be confirmed to even more closely approximate the actual measured values Fₘ than the corrected calculated values F_{cx}.

### Experiment 3

Next, the result of experiment 3 will be described. In experiment 3, a peeling test similar to that of the foregoing experiment 2 was conducted at a constant peeling speed while changing the thickness of the test film.

### Experiment Conditions

The peeling speed was a constant speed of 300 [mm/min]. The thicknesses of the test films were set in the following five patterns (comparative examples):
Comparative example 2-1: 25-μm-thick substrate+30-μm-thick adhesive
Comparative example 2-2: 50-μm-thick substrate+30-μm-thick adhesive
Comparative example 2-3: 75-μm-thick substrate+30-μm-thick adhesive
Comparative example 2-4: 100-μm-thick substrate+30-μm-thick adhesive

### Calculated Values

Examples corresponding to the foregoing comparative examples were as follows:
Example 2-1: 25-μm-thick substrate+30-μm-thick adhesive
Example 2-2: 50-μm-thick substrate+30-μm-thick adhesive
Example 2-3: 75-μm-thick substrate+30-μm-thick adhesive
Example 2-4: 100-μm-thick substrate+30-μm-thick adhesive
   In each of the examples, the calculated value F_{c} of the peeling force at each peeling angle was calculated with the constant n=0.58 in the foregoing Eq. (1). The actual measured value Fₘ substituted into the foregoing Eq. (1) was the value at a peeling angle θ of 90 [°].

### Corrected Calculated Values

In each of the following examples, the corrected calculated value F_{cx} of the peeling force at each peeling angle was calculated with the constant n1=0.2 in the foregoing Eq. (4) when the peeling angle θ was in the range of 90≤θ<180:
Example 2-5: 25-μm-thick substrate+30-μm-thick adhesive
Example 2-6: 50-μm-thick substrate+30-μm-thick adhesive
Example 2-7: 75-μm-thick substrate+30-μm-thick adhesive
Example 2-8: 100-μm-thick substrate+30-μm-thick adhesive
   In the range where the peeling angle θ was 0<θ<90, the calculated value F_{c} of the peeling force was calculated using the foregoing Eq. (1) with the constant n=0.58. The corrected calculated values F_{cx} in this range agree with the calculated values F_{c}.

FIG. 21 shows the values of comparative example 2-1 and examples 2-1 and 2-5 at each peeling angle, with a substrate thickness of 25 [μm].

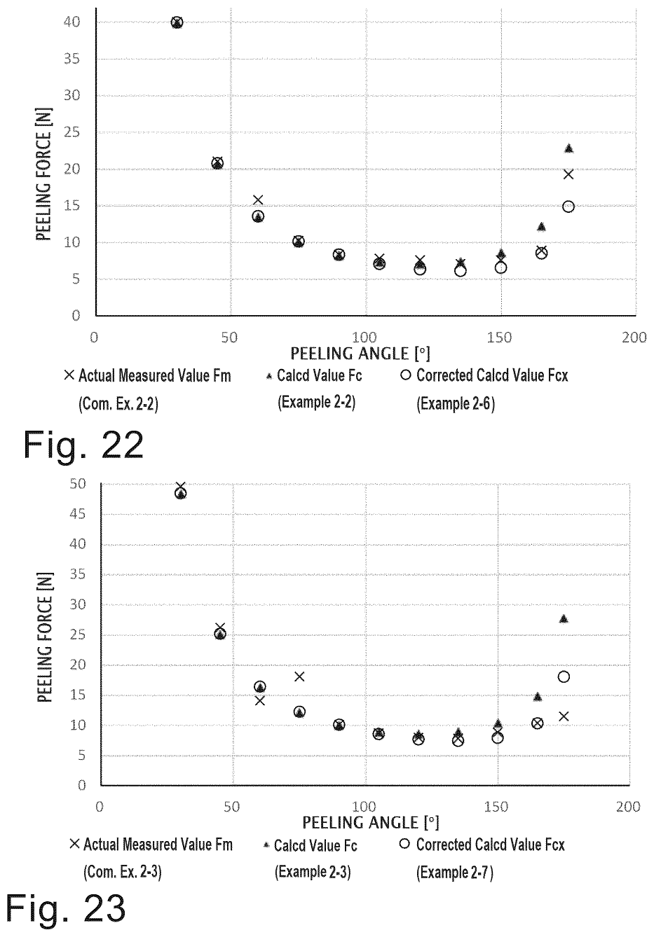

FIG. 22 shows the values of comparative example 2-2 and examples 2-2 and 2-6 at each peeling angle, with a substrate thickness of 50 [μm].

FIG. 23 shows the values of comparative example 2-3 and examples 2-3 and 2-7 at each peeling angle, with a substrate thickness of 75 [μm].

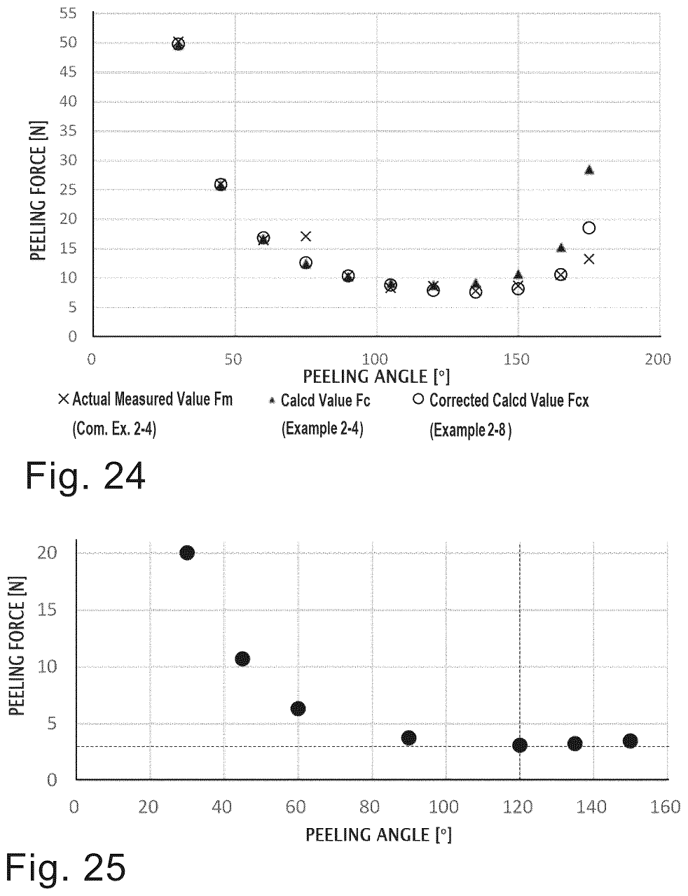

FIG. 24 shows the values of comparative example 2-4 and examples 2-4 and 2-8 at each peeling angle, with a substrate thickness of 100 [μm].

### Comparative Analysis

As shown in FIGS. 21 to 24, the calculated values F_{c} of the foregoing Eq. (1) tend to approximate the actual measured values Fₘ at any substrate thickness. If the peeling angle θ is in the range of 90≤θ<180, the corrected calculated values F_{cx} calculated using the foregoing Eq. (4) can be confirmed to more closely approximate the actual measured values Fₘ than the calculated values F_{c}.

### Experiment 4

Next, experiment 4 will be described. In experiment 4, a constant-speed peeling test was simulated by conducting a constant-speed tensile peeling test in seven patterns to be described below, and the foregoing Eqs. (1) and (4) were verified based on the results.

### Experiment Conditions

A constant-speed tensile peeling test was conducted in each of the following patterns, with an adhesive cellophane tape (tape width: 18 [mm], tape thickness: 0.05 [mm]) attached to a 304-stainless steel base member as a test film:
Pattern 1: peeling speed 0.67 [mm/s], peeling angle 30 [°]
Pattern 2: peeling speed 1.45 [mm/s], peeling angle 45 [°]
Pattern 3: peeling speed 2.5 [mm/s], peeling angle 60 [°]
Pattern 4: peeling speed 5.0 [mm/s], peeling angle 90 [°]
Pattern 5: peeling speed 7.5 [mm/s], peeling angle 120 [°]
Pattern 6: peeling speed 8.54 [mm/s], peeling angle 135 [°]
Pattern 7: peeling speed 9.33 [mm/s], peeling angle 150 [°]

### Experimental Result

FIG. 25 is a graph where the actual measured values Fₘ of the peeling forces obtained from the foregoing patterns are plotted. The results of FIG. 25 simulate a constant-speed peeling test at a peeling speed of 5 [mm/s]. From FIG. 25, it can be seen that the peeling force is minimized at a peeling angle θ of 120 [°]. Since the calculated values F_{c} of the peeling force calculated using the foregoing Eqs. (1) and (4) are also minimized at a peeling angle θ=120 [°], it is considered that the calculated values F_{c} can be calculated without problem using the foregoing Eqs. (1) and (4).

According to the peeling force estimation method and the like of the present invention, the peeling force at various peeling angles can be estimated by a simple technique.

### REFERENCES SIGNS LIST

1 adherend
1x adherend surface
2 base
3 test film holder
3a holding surface
4 load measuring instrument
5 linear moving body
6 rotary support
7 slide movement mechanism
8 peeling phenomenon measurement sensor
11 other-end side support unit
15, 15A direction conversion member
16, 16A transmission member
18 one-end side support unit
20 biasing member
100 peeling test apparatus
200 control apparatus
201 actual measured value acquisition unit
202 calculation formula storage unit
203 peeling angle determination unit
204 peeling force calculation unit
D1 surface length direction
D2 height direction
D3 longitudinal direction
O1 rotation center axis
O2 direction conversion axis
P peeling position
T test film

### CITATION LIST

Patent Literature 1: Japanese Patent Application Laid-Open No. 2006-194599 A

What is claimed is:

1. A peeling force estimation method for estimating peeling force in peeling a test film from an adherend surface by pulling one end of the test film that has separated from the adherend surface, where the test film is in a state of being attached to the adherend surface along a surface length direction of the adherend surface, the peeling force estimation method comprising:
actually measuring the peeling force at a predetermined peeling angle (hereinafter, referred to as an actual measurement angle) using a peeling test apparatus to acquire an actual measured value of the peeling force, the peeling angle being defined as an angle formed between the test film and the adherend surface; and
calculating the peeling force at a certain peeling angle other than the actual measurement angle using the actual measured value and a predetermined calculation formula representing a relationship between the peeling angle and the peeling force.

2. The peeling force estimation method according to claim 1, wherein an equation including 1/{(1−cos θ) sin θ} is employed as the calculation formula for calculating the peeling force, where θ [°] is the peeling angle.

3. The peeling force estimation method according to claim 1, wherein in calculating the peeling force,
the following Eq. (1) for calculating a calculated value F_{c} [N] of the peeling force corresponding to the peeling angle is employed as the calculation formula, and the calculated value F_{c} of the peeling force at the peeling angle is calculated using the following Eq. (3) derived from the following Eq. (2) and Eq. (1):
$${F}_{c} = γ L / {\{ ( 1 - cos θ ) sin θ \}}^{n} \qquad ( 1 )$$
$${F}_{m} = γ L / {\{ ( 1 - cos {θ}_{m} ) sin {θ}_{m} \}}^{n} \qquad ( 2 )$$
$${F}_{c} = {F}_{m} \cdot {[ \{ ( 1 - cos {θ}_{m} ) sin {θ}_{m} \} / \{ ( 1 - cos θ ) sin θ \} ]}^{n} \qquad ( 3 )$$
where θ [°] is the peeling angle, L [mm] is a film width that is a dimension of the test film in a film width direction intersecting the surface length direction, γ [N/mm] is adhesive force of the test film, n is a predetermined constant smaller than 1, θₘ [°] is the actual measurement angle, and Fₘ [N] is the actual measured value, Eq. (2) being obtained by substituting the actual measured value Fₘ into the calculated value F_{c} of the peeling force and substituting the actual measurement angle θₘ into the peeling angle θ in Eq. (1).

4. The peeling force estimation method according to claim 1, wherein the following Eq. (3) is satisfied:
$${F}_{c} = {F}_{m} \cdot {[ \{ ( 1 - cos {θ}_{m} ) sin {θ}_{m} \} / \{ ( 1 - cos θ ) sin θ \} ]}^{n} \qquad ( 3 )$$
where θ [°] is the peeling angle, L [mm] is a film width that is a dimension of the test film in a film width direction interesting the surface length direction, γ [N/mm] is adhesive force of the test film, n is a predetermined constant smaller than 1, θₘ [°] is the actual measurement angle, Fₘ [N] is the actual measured value, and F_{c} is a calculated value of the peeling force.

5. The peeling force estimation method according to claim 3, wherein the actual measurement angle θₘ is 90 [°].

6. The peeling force estimation method according to claim 3, wherein the constant n when the peeling angle θ is an angle θ2 is set to be smaller than the constant n when the peeling angle θ is an angle θ1, the angle θ2 being greater than the angle θ1.

7. The peeling force estimation method according to claim 3, wherein when the peeling angle θ falls within a range of α≤θ<180, the calculated value F_{c} of the peeling force at the peeling angle is calculated using a corrected formula obtained by correcting Eq. (3), where α [°] is a predetermined threshold.

8. The peeling force estimation method according to claim 7, wherein the corrected formula is the following Eq. (4):
$${F}_{c} = {F}_{m} \cdot {[ \{ ( 1 - cos {θ}_{m} ) sin {θ}_{m} \} / \{ ( 1 - cos θ ) sin θ \} ]}^{n 1} \qquad ( 4 )$$
where the constant n in Eq. (3) is replaced with a constant n1, the constant n1 being smaller than the constant n when the peeling angle θ is in a range of 0<θ<α.

9. The peeling force estimation method according to claim 7, wherein the threshold α satisfies 90≤α<180.

10. The peeling force estimation method according to claim 8, wherein the constant n satisfies 0.4≤n≤0.7, and the constant n1 satisfies 0.1≤n1≤0.4.

11. A peeling test apparatus for peeling a test film from an adherend surface extending in a surface length direction by pulling one end of the test film that has separated from the adherend surface, where the test film is in a state of being attached to the adherend surface along the surface length direction, the peeling test apparatus comprising:
an adherend having the adherend surface;
a base configured to support the adherend;
a test film holder that is disposed on the base and is configured to support the one end of the test film;
a linear moving body that is disposed on the base and is configured to linearly move the adherend with respect to the base in a longitudinal direction in which the adherend approaches and recedes from the test film holder;
a rotary support that is interposed between the linear moving body and the adherend and is configured to enable rotation of the adherend with respect to the linear moving body and about a rotation center axis extending in a height direction intersecting the surface length direction and the longitudinal direction, the height direction being a film width direction of the test film attached to the adherend surface;
a slide movement mechanism configured to move the adherend to slide in the surface length direction with respect to the linear moving body and the rotary support;
a load measuring instrument configured to measure a load in the longitudinal direction in peeling the test film from the adherend surface; and
a control apparatus configured to acquire an output signal of the load measuring instrument and to enable estimation of peeling force at each peeling angle by calculation, the peeling angle being defined as an angle formed between the test film and the adherend, wherein
the control apparatus includes:
an actual measured value acquisition unit configured to acquire an actual measured value of the peeling force at a predetermined peeling angle (hereinafter, referred to as an actual measurement angle) on a basis of data actually measured by the load measuring instrument;
a calculation formula storage unit configured to store a predetermined calculation formula representing a relationship between the peeling angle and the peeling force; and
a peeling force calculation unit configured to calculate, using the actual measured value and the calculation formula, the peeling force at a certain peeling angle other than the actual measurement angle.
